(19) United States
(12) Patent Application Publication
(10) Pub. No.: US 2011/0304629 A1
(43) Pub. Date: Dec. 15, 2011

(54) REAL-TIME ANIMATION OF FACIAL EXPRESSIONS

(75) Inventor: Royal Dwayne Winchester, Sammamish, WA (US)

(73) Assignee: Microsoft Corporation, Redmond, WA (US)

(21) Appl. No.: 12/796,682

(22) Filed: Jun. 9, 2010

(51) Int. Cl. G06T 15/70

(52) U.S. Cl. 345/473

(57) ABSTRACT

Animation of a character, such as a video game avatar, to reflect facial expressions of an individual in real-time is described herein. An image sensor is configured to generate a video stream, wherein frames of the video stream include a face of an individual. Facial recognition software is utilized to extract data from the video stream that is indicative of facial expressions of the individual. A three-dimensional rig is driven based at least in part upon the data that is indicative of facial expressions of the individual, and an avatar is animated to reflect the facial expressions of the user in real-time based at least in part upon the three-dimensional rig.

### BACKGROUND

Video game consoles generally allow players of video games to take part in an interactive experience displayed on a display screen by way of such a console. Video game consoles have improved from machines that support low resolution graphics to machines that can render graphics on displays in relatively high resolution. Thus, designers of video games can design very detailed scenes to be displayed to a player of a video game.

Generally, a video game player can control the action of a graphical object displayed to the individual on a display screen, wherein oftentimes a graphical object is a character. Characters in video games range from relatively realistic representations of a person or animal to more cartoonish representations of a person or animal. Typically, the individual uses a controller that includes a directional pad and several buttons to control movements/actions of a character displayed on the display screen by way of a video game console.

Recently, video game consoles have been equipped with local storage thereon such that individuals can save data pertaining to the video game console and/or a certain game. In a particular example, an individual can create an avatar, which is a representation of the individual or an alter ego of such individual. Oftentimes, an avatar is displayed as a three-dimensional character, and a user can select various styles pertaining to the avatar including, but not limited to, shape of the body of the avatar, skin tone of the avatar, facial features of the avatar, hair style of the avatar, etc. These avatars are generally somewhat cartoonish in nature; however, avatar design is not limited to cartoonish representations of individuals.

When playing a game of a certain type, an individual may play the game as their avatar. While the avatar may in some way resemble the individual or an alter ego of the individual, the avatar does not emote like the individual. Rather, emotions of the avatar as displayed on a display screen are pre-programmed depending on context within the video game. Thus, if something undesirable happens in the video game pertaining to the avatar, it could be preprogrammed that the avatar will frown. In many instances, however, these emotions may not reflect the emotions of the actual game player.

### SUMMARY

The following is a brief summary of subject matter that is described in greater detail herein. This summary is not intended to be limiting as to the scope of the claims.

Described herein are various technologies pertaining to capturing facial expressions of an individual and causing such facial expressions to be reflected in real-time on an animated avatar. Pursuant to an example, a sensor unit can have a video camera housed therein (e.g., a RGB camera). The video camera can be directed toward an individual and can capture actions of the individual. The resulting video stream can be analyzed using, for instance, existing facial recognition applications. Data that is indicative of facial expressions of the individual captured in the video stream can be extracted from such video stream and can be utilized to drive a three-dimensional rig. Thus, the data that is indicative of the facial expressions of the individual can be mapped to certain portions of the three-dimensional rig such that as the facial expressions of the individual change, such changes in facial expression are also occurring in the three-dimensional rig. In an example, the three-dimensional rig may thereafter be rendered to a display such that a face is animated to reflect the facial expressions of the individual in real-time.

Furthermore, the three-dimensional rig can be utilized in connection with animating facial expressions of an avatar that corresponds to the captured facial expressions of the user. The individual may customize the avatar such that the avatar in the mind of the individual sufficiently represents the individual or an alter ego of the individual. Thus, such individual can select a hairstyle, hair color, eye style, eye color, shape of mouth, shape of lips and various other facial features such that the avatar is representative of the individual or the alter ego thereof. When rendering the avatar to represent the facial features of the individual corresponding thereto, styles selected by such individual can be applied to (e.g., essentially pasted onto) the three-dimensional rig. The three-dimensional rig (including a mesh/skin corresponding thereto) may then be projected into a two-dimensional space, and the styles can be represented as certain textures on a desired two-dimensional object. As the three-dimensional rig changes over time to represent the facial expressions of the user, the styles can move together with the three-dimensional rig. Thus, for instance, if the individual raises an eyebrow while playing a game, a portion of the three-dimensional rig corresponding to the eyebrow will rise and the style applied to the three-dimensional rig will also rise. The two-dimensional textures corresponding to the styles can be processed through utilization of a graphical processing unit (GPU), and can be placed on a cartoonish face to give the appearance of the avatar emoting as the individual emotes during game play.

In an example, these features described above can be utilized in a video game environment, wherein the user can control actions of the avatar by way of some suitable motion. Specifically, the sensor unit can be configured to capture actions/commands of the individual by way of the video stream, audio data, depth information, etc., and such actions/commands can control actions of the avatar on the display screen. Moreover, as the individual exhibits emotions while playing a game, such emotions can be captured and represented on the face of the avatar in the game. Therefore, in an example, the individual can ascertain how she is emoting when playing the video game by watching the emotions of the avatar.

In another embodiment, the features described above can be utilized in a multi-player setting, wherein different players are located at remote locations looking at different screens. That is, a first individual may have an avatar corresponding thereto and such avatar is utilized in a multi-player game. The sensor unit can be configured to output a video stream that includes images of a face of the first individual. Thereafter, as described above, the video stream can be analyzed to extract data therefrom that is indicative of facial expressions of the first individual. This can occur at a video game console of the first individual and/or at another video game console that is being utilized by a second individual. At the video game console of the second individual, a three-dimensional rig can be driven based at least in part upon the data indicative of the facial expressions of the first individual, and these facial expressions can be displayed on an avatar that represents the first individual on the display seen by the second individual. Accordingly, the first individual can have a telepresence or pseudopresence by way of the avatar on the display being viewed by the second individual, as the second individual can see how the individual is emoting as they are playing the game together or against each other.

Other aspects will be appreciated upon reading and understanding the attached figures and description.

### BRIEF DESCRIPTION OF THE DRAWINGS

FIG. 1 is a functional block diagram of an example system that facilitates animating an avatar to reflect real life emotions of an individual in real-time.

FIG. 2 is a functional block diagram of an example system that facilitates applying certain styles to an avatar.

FIG. 3 is an example graphical user interface that can be utilized in connection with applying styles to an avatar.

FIG. 4 is an example depiction of two individuals playing a game such that emotions of such individuals are represented in real time by avatars corresponding to the individuals.

FIG. 5 is an example depiction of two individuals playing a game in separate locations, wherein emotions of such individuals are represented in animated avatars.

FIG. 6 is a flow diagram that illustrates an example methodology for causing an avatar to be animated on a display screen with facial expressions that correspond to facial expressions of the individual that the avatar represents.

FIG. 7 is a flow diagram that illustrates an example methodology for causing an avatar to be animated on a display screen to reflect facial expressions of an individual represented by the avatar.

FIG. 8 is an example computing system.

### DETAILED DESCRIPTION

Various technologies pertaining to animating avatars to reflect facial expressions/emotions of individuals represented by such avatars in real time will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

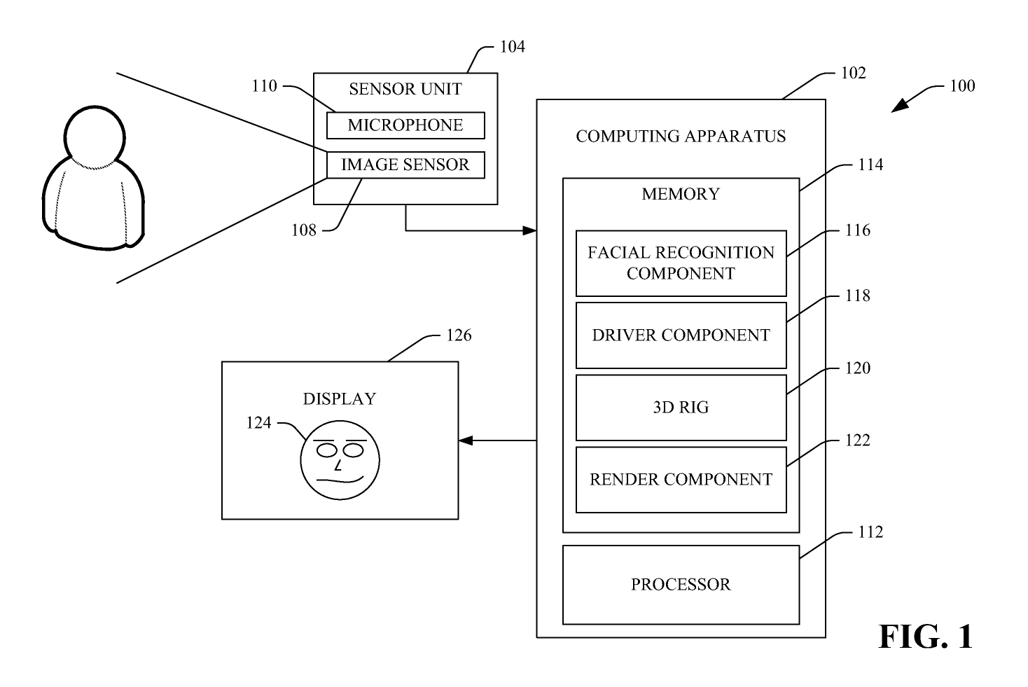

With reference to FIG. 1, an example system 100 that facilitates animating an avatar such that facial expressions of an individual represented by the avatar are rendered on a display is illustrated. The system 100 includes a computing apparatus 102. Pursuant to an example, the computing apparatus 102 can be a video game console that can be communicatively coupled to a display screen, such as a television display. In another example, the computing apparatus 102 may be a mobile/portable gaming apparatus that comprises a display screen thereon. In yet another example, the computing apparatus 102 can be a portable computing device that is not a dedicated gaming device such as a portable telephone or multimedia apparatus. Furthermore, the computing apparatus 102 may be a conventional personal computer or laptop computer. While examples of the system 100 described herein pertain to the video gaming environment, it is to be understood that technology described herein may also be applied to other environments where telepresence is desired and where an individual can be represented through utilization of an avatar/character. Thus, for example, technologies described herein may be employed in an environment where two individuals wish to correspond with one another via a pseudo video conference environment but wherein, instead of transmitting or displaying actual video data, an avatar representing participants in the video conference is rendered. Other embodiments will be readily understood by one of ordinary skill in the art.

The system 100 further comprises a sensor unit 104 that is in communication with the computing apparatus 102. For example, the sensor unit 104 may have a battery therein and may communicate with the computing apparatus 102 by way of a wireless connection. In another example, the sensor unit 104 may have a wire line connection to the computing apparatus 102 and may be powered via the computing apparatus 102. In still yet another example, the sensor unit 104 may be included in the computing apparatus 102 (e.g., included in the same housing that comprises a processor and memory of the computing apparatus). The sensor unit 104 may be directed at an individual 106 to capture certain movements/actions of the individual 106. Specifically, the sensor unit 104 can include an image sensor 108 such as a RGB video camera that can capture images and/or motion of the individual 106. The sensor unit 104 may also comprise a microphone 110 that is configured to capture audible output of the individual 106. Additionally, while not shown, the sensor unit 104 may further comprise a depth sensor that is configured to sense a distance of the individual 106 and/or certain portions of the individual 106 from the sensor unit 104. The depth sensor can utilize infrared light and reflectance to determine various distances from the sensor unit 104 to different parts of the individual 106. Of course, other technologies for performing depth sensing are contemplated and are intended to fall under the scope of the hereto appended claims.

Pursuant to an example, the sensor unit 104 can be directed at the individual 106 such that the image sensor 108 captures motion data (e.g., video or other suitable data) pertaining to the individual 106 as such individual 106 is moving and/or expressing emotions via facial expressions. The sensor unit 104 can be configured to output captured images that are intended for receipt by the computer apparatus 102. Thus, the sensor unit 104 may be configured to output a motion data stream, wherein the motion data stream may be a video stream that includes images of the individual 106, and particularly includes images of a face of the individual 106. In other examples, an infrared camera can be configured to capture motion data pertaining to the individual, and such motion data can include that that is indicative of facial expressions of the individual. Other motion capture techniques are contemplated and are intended to fall under the scope of the hereto-appended claims.

The computing apparatus 102 comprises a processor 112, which can be a general purpose processor, a graphical processing unit (GPU) and/or other suitable processor. The computing apparatus 102 also comprises memory 114 which includes various components that are executable by the processor 112. In an example, the memory 114 can include a facial recognition component 116 that receives the video stream output from the sensor unit 104 and analyzes such video stream to extract data that is indicative of facial features of the individual 106. Specifically, the facial recognition component 116 can recognize existence of a human face in the motion data stream (e.g., video data stream) output by the sensor unit 104 and can further extract data that is indicative of facial expressions upon the face of the individual 106. This can include location of a jaw line, movement of cheeks, location and movement of eyebrows and other portions of the face that can indicate facial expressions of the individual 106.

A driver component 118 can receive the data that is indicative of the facial expressions of the individual 106 and can drive a three-dimensional rig 120 based at least in part upon the data that is indicative of the facial expressions. For example, the three-dimensional (3D) rig 120 can be in a form that is human-like in nature. As will be understood by one skilled in the art of graphical animation, the 3D rig 120 can comprise a skin that is utilized to draw the surface of the avatar and a hierarchical set of bones. Each bone has a 3D transformation which includes a position of the bone, scale of the bone and orientation of the bone and optionally a parent bone. Thus, bones can form a hierarchy such that the full transform of a child node/bone in the hierarchy is the product a transformation of its parent and its own transformation. Rigging (graphically animating a character through utilization of skeletal animation) will be understood and recognized by one skilled in the art of graphical animation. While the memory 114 is shown as including a single 3D rig, it is to be understood that the memory 114 may comprise multiple 3D rigs, and an appropriate 3D rig can be selected based at least in part upon recognized shape of the face of an individual being captured by the image sensor 108.

A driver component 118 can be configured to drive the 3D rig 120 based at least in part upon the data that is indicative of the facial expressions of the individual 106. Thus, if the data indicative of facial expressions indicates that a jaw line of the individual is moving in a downward direction, the driver component 118 can cause a corresponding jaw line in the 3D rig 120 to move in the downward direction. In another example, if the data indicative of the facial expressions of the individual 106 show that the eyebrows of the individual 106 are moving in an upward direction, the driver component 118 can drive the corresponding location in the 3D rig 120 (near the eyebrows of the 3D rig) to move in an upward direction.

A render component 122 can graphically render an avatar 124 on a display 126 based at least in part upon the 3D rig 120 driven by the driver component 118. In more detail the render component 122 can animate the avatar 124 such that the facial expressions of the avatar 124 reflect the facial expressions of the individual 106 in real time. Thus, as the individual 106 smiles, frowns, smirks, looks quizzical, expresses angst, etc. such expressions are represented on the avatar 124 on a display 126.

The display 126 may be a television display, wherein such television display is in communication with the computing apparatus 102. In another example, the display 126 may be a computer monitor or may be a display that is included in the computing apparatus 102 (e.g., when the computing apparatus 102 is a portable gaming apparatus).

While the driver component 118 has been described herein as driving the 3D rig 120 based solely upon the video data output by the image sensor 108, it is to be understood that the driver component 118 can be configured to drive the 3D rig 120 through utilization of other data. For example, the driver component 118 may receive audible data from the microphone 110, wherein such audio data includes words spoken by the individual 106. Certain sounds can cause the mouth of the individual 106 to be of certain shapes, and the driver component 118 can drive the 3D rig 120 based at least in part upon shapes that are associated with certain sounds output by the individual 106. In addition, the sensor unit 104 may include a depth sensor and the driver component 118 can drive the 3D rig 120 based at least in part upon data output by the depth sensor.

In an exemplary embodiment, the system 100 may be utilized in the context of a video game. The individual 106 may create an avatar that is a representation of the individual 106 or an alter ego thereof and may begin playing a video game that allows the user or individual 106 to play the game as the avatar 124. As the expressions of the individual 106 change during game play, the expressions animated on the avatar 124 also change in a corresponding manner in real time. Thus, the individual 106 can see during game play how such individual 106 is emoting. In another example, the display 126 may be remote from the individual 106 such as when the individual 106 is playing with or against another game player. Therefore, another game player can view the display 126 which displays the avatar 124 emoting as the facial expressions of the individual 106 change during game play. Still further, the system 100 may be used in a pseudo videoconference application, wherein the individual 106 is communicating with another person and is represented by the avatar 124. The person with which the individual 106 is communicating can be presented with the avatar 124 that expresses emotion/shows facial expressions that correspond to the emotions/facial expressions of the individual 106.

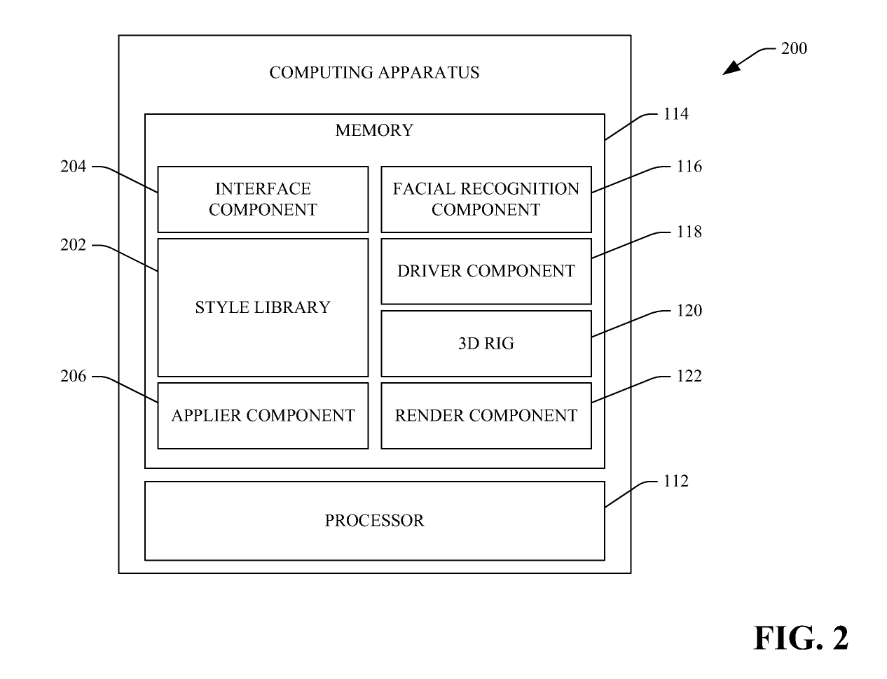

Now referring to FIG. 2, another example computing apparatus 200 that is configured to cause an avatar to be animated on a display while representing facial expressions of an individual corresponding to the avatar is illustrated. The computing apparatus 200 includes the processor 112 and the memory 114 as described above. In this example computing apparatus 200 the memory 114 comprises a style library 202 that includes a plurality of different types of styles that can be associated with an avatar. For example, these styles may include shape of a face, different facial features including eyebrows, eyes, nose, mouth, ears, beard, hair, etc. An interface component 118 can allow an individual to create a customized avatar that represents such individual by applying styles from the style library 202 to one or more templates (e.g., a template face shape, a template body shape, . . . ).

Pursuant to an example, an individual can be provided with a graphical user interface that walks the individual through creating an avatar that represents the individual or an alter ego thereof. The graphical user interface can first present the individual with different body types. Thereafter, the individual can be presented with different shapes of a face (e.g., round, ovular, square, triangular, etc.). The individual may then select a shape of eyes, a color of eyes, a position of eyes on the face of the avatar, a shape of a nose or size of a nose, a position of a nose on the face of the avatar, a shape of a mouth, size of mouth, color of mouth, etc. By selecting a plurality of predefined styles to apply to the avatar, the individual can generate a representation of himself or an alter ego of himself.

The memory 114 of the computing apparatus 200 also comprises the facial recognition component 116, the driver component 118 and the 3D rig 120, which can act as described above. The memory 114 may also comprise an applier component 206 that can apply at least one style selected by the individual via the interface component 204 to an appropriate position on the 3D rig 120. Therefore, if the style is an eyebrow, the eyebrow can be placed in an appropriate position on the mesh of the 3D rig 120. Similarly, if the style is a mouth, such mouth can be placed in an appropriate position on the mesh of the 3D rig 120.

As indicated above, the 3D rig 120 may be in a human-like form. If it is desired that the render component 122 render a non-human like character (e.g., a cartoonish avatar), then it becomes desirable to animate the styles but not the human like appearance of the 3D rig 120. These styles may be animated on a 2D template head of an avatar. To animate a particular style, the style can be placed at an appropriate position on the 3D rig 120, and movement of such style can be captured as the individual makes different facial expressions. That is, as the individual 106 raises his or her eyebrows, the appropriate portion of the 3D rig 120 will also raise, causing a style placed at the eyebrow region of the 3D rig 120 to rise. These styles pasted onto the 3D rig 120 can be captured using the processor 112 (which can be a GPU) to represent the eyebrow moving up and down. That is, each frame of the processor 112 can be configured to draw a texture corresponding to the style, and such texture can change on every frame and be applied to the template face of the avatar. Therefore, the style selected by the individual now appears as if it is animating to follow the facial expressions of the individual 106 as captured by the image sensor 108.

To perform the animation of the styles on the blank template, the processor 112 can be configured to generate vertices, stitch triangles into the vertices, fill triangles with a color corresponding to the styles, and animate such styles in accordance with the movement of the 3D rig 120. The processor 112 can be configured to animate the styles in each frame to display a smooth animation on a display screen. In summary, video data can be received at the computing apparatus 200 and is mapped to the 3D rig 120 by the driver component 118. Styles can be applied to the 3D rig 120 in appropriate positions and the resulting 3D model with the styles applied thereto can be projected into a 2D model by the render component 122. The 2D model is then utilized to generate textures (that correspond to the styles) that can be animated on an avatar, and this animation happens in real-time.

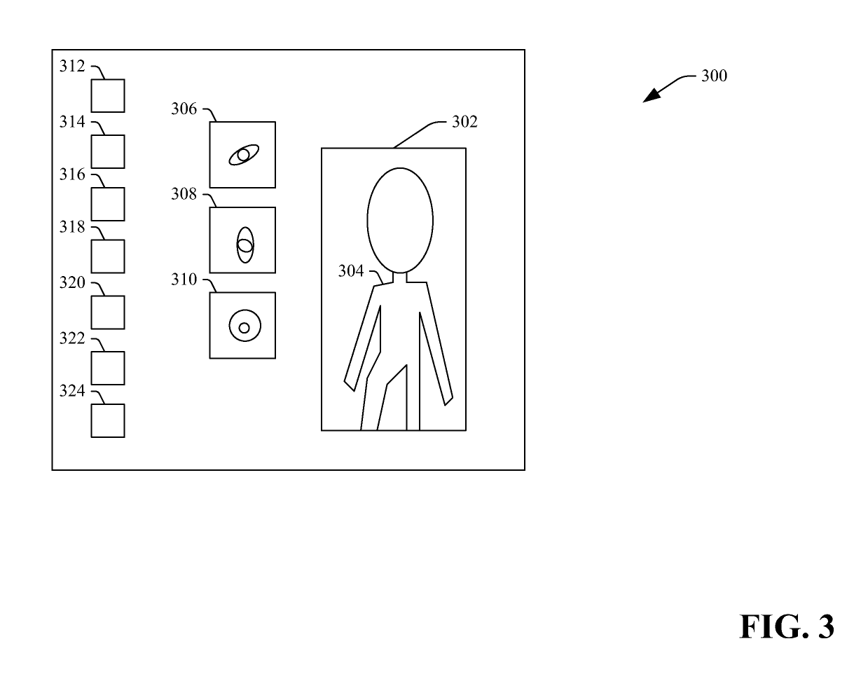

Referring now to FIG. 3, an example graphical user interface 300 that can be provided to an individual that can be utilized to generate an avatar that represents such individual or an alter ego thereof is illustrated. The graphical user interface 300 may include a first window 302 that comprises an avatar 304 with styles currently selected by the individual. Additionally, the avatar 304 may appear blank (the face of the avatar 304 may appear blank). The graphical user interface 300 may also comprise a plurality of graphical items 306-310 that represent selectable facial features. As shown, the facial features in this example are shapes of eyes that can be applied to the avatar 304. By selecting one of the graphical items 306-310, the corresponding eye shape will appear on the avatar 304. The individual may then choose a color of eye by selecting one of the selectable graphical items 312-324. Once the individual has selected the appropriate shape of eye and corresponding color, other styles may be presented to the individual for selection. Again such styles may include shape of eyebrows, type of eyebrows, color of eyebrows, shape of nose, beard or no beard, etc.

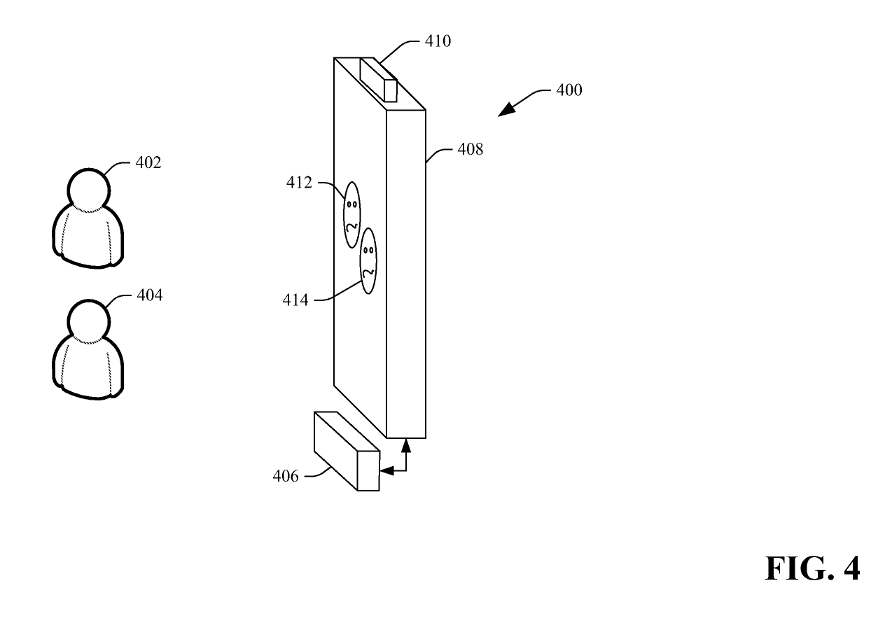

Referring now to FIG. 4 an example embodiment 400 where avatars can be animated to show facial expressions of individuals is illustrated. In this example embodiment 400, a first individuals 402 and a second individual 404 are playing a video game through a particular video game console 406. The video game console 406 is coupled to a television 408. A sensor unit 410 is communicatively coupled to the video game console 406 and includes an image sensor that captures images of the first and second individuals 402 and 404.

In the game being played by the individuals 402 and 404, two avatars 412 and 414 that represent the individuals 402 and 404 are utilized displayed and utilized during game play. Specifically, the avatar 412 can represent the first individual 402 and the avatar 414 can represent the second individual 404. As the individuals 402 and 404 are playing the game, they can ascertain how their co-player/competitor is emoting by watching the facial expression animated on the avatars 412-414. This can enhance game play by providing the players with realistic emotions captured in real time by the sensor unit 410.

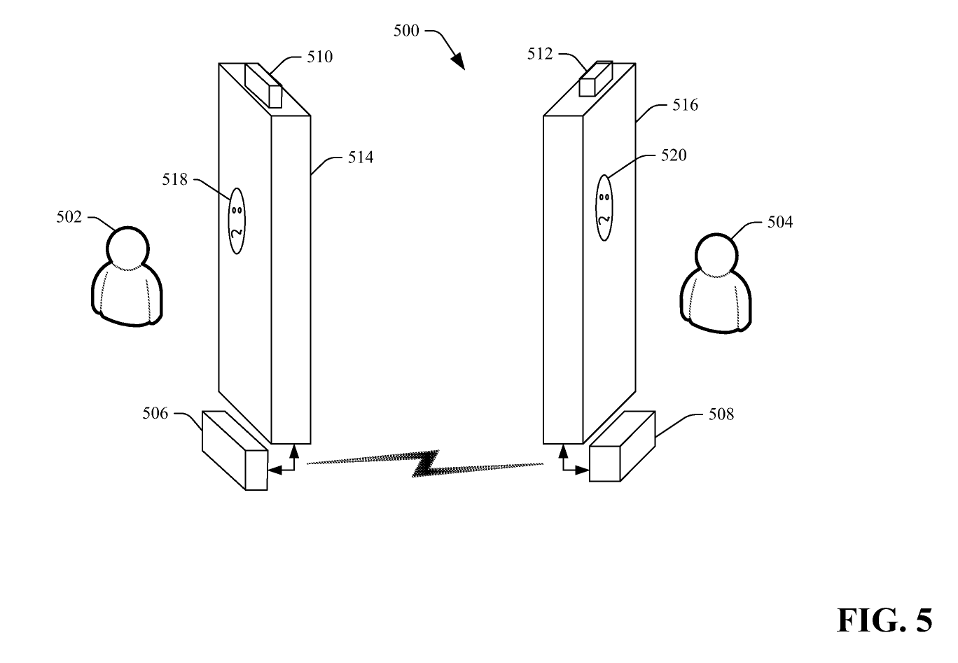

Turning now to FIG. 5, another example embodiment 500 pertaining to video game play is illustrated. In this embodiment, a first individual 502 and a second individual 504 are playing a game together or against each other at remote locations. Two video game consoles 506 and 508 utilized by the individuals 502 and 504, respectively, to play the game are coupled to one another by way of a network connection. This allows the individuals 502 and 504 to play with or against each other even if the individuals 502 and 504 are geographically separated from one another by a considerable distance. Each of the video game consoles 506 and 508 have sensor units 510 and 512, respectively, corresponding thereto. The sensor unit 510 can include an image sensor that can generate a video stream that captures facial expressions of the first individual 502 and the sensor unit 512 can include an image sensor that generates a video stream that captures facial expressions of the second individual 504 as such individuals 502 and 504 are playing the game with or against one another.

The video game console 506 can cause animated graphics to be displayed on a display 514 to the first individual 502 while the video game console 508 can cause animation pertaining to the game to be displayed on a display 516. The animation displayed on the display 514 to the first individual 502 can be an animated avatar 518 that represents the second individual 504. The avatar 518 can be animated to display facial expressions of the second individual 504 in real-time as the second individual 504 is reacting to game play. Similarly, the video game console 508 can cause an avatar 520 that represents the first individual 502 to be displayed to the second individual 504. This avatar 518 can be animated to depict facial expressions of the first individual 502 as such first individual 502 emotes during game play.

There are various embodiments that can enable this online game play where facial expressions of players are animated in real time. In a first embodiment, a video stream output by the sensor unit 510 can be processed at the first video game console 506 such that data indicative of facial expressions of the first individual 502 is extracted at the first video game console 506. Thereafter this data indicative of the facial expressions of the individual 502 can be transmitted via the network to the video game console 508 that is used by the second individual 504. In alternative embodiments, the video stream output by the sensor unit 510 can be transmitted directly to the game console 508 corresponding to the second individual 504 via the game console 506. The game console 508 may then extract the data indicative of facial expressions of the first individual 502 at the video game console 508 and the video game console 508 can drive a 3D rig thereon to cause the avatar 518 to be animated to reflect facial expressions of the first individual 502. In still yet another embodiment, a centralized server (not shown) can perform the data processing and a server can then transmit processed data to the second video game console 508. Thus, in summary processing undertaken to allow the video game consoles 506 and 508 to animate the avatars 516 and 518, respectively, to reflect facial expressions of the individuals 502 and 504 can occur at either the video game console 506 or the video game console 508, may be split between the video game console 506 and 508, or may be offloaded to a server.

Additionally, while embodiments described herein pertain to animating facial expressions of users on an avatar, one or more features described above can be utilized to animate other portions of an avatar. For example, an individual may customize their avatar by causing the avatar to have a certain belt buckle. The belt buckle can be applied to a 3D rig of a human body, and analysis of a video stream that captures the individual can be utilized to drive the 3D rig. The style (the belt buckle) can be placed at the appropriate location on the 3D rig, and the style can be projected into a 2-dimensional scene for animating on an avatar.

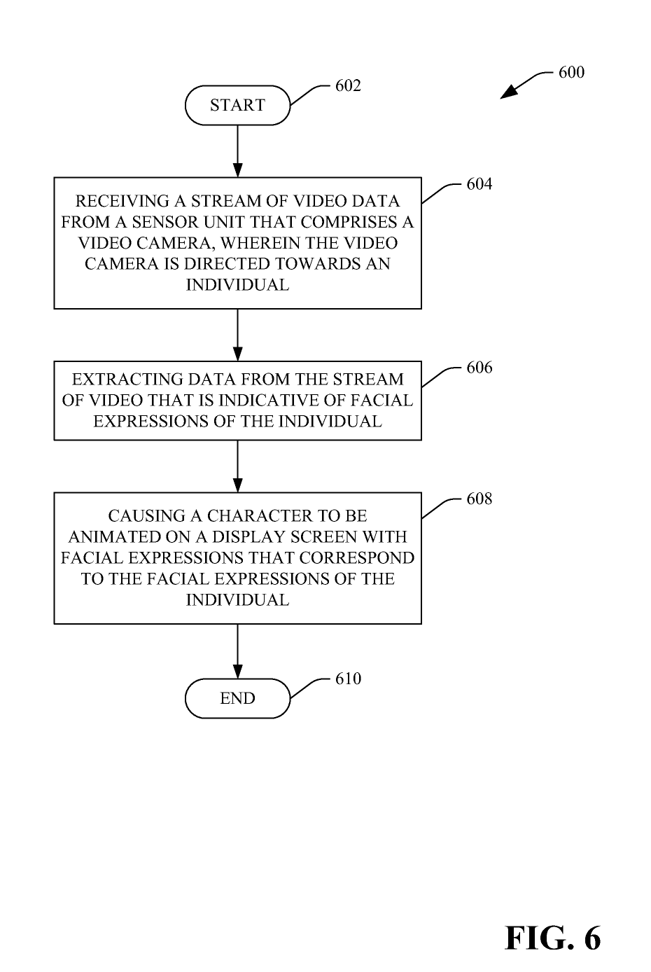

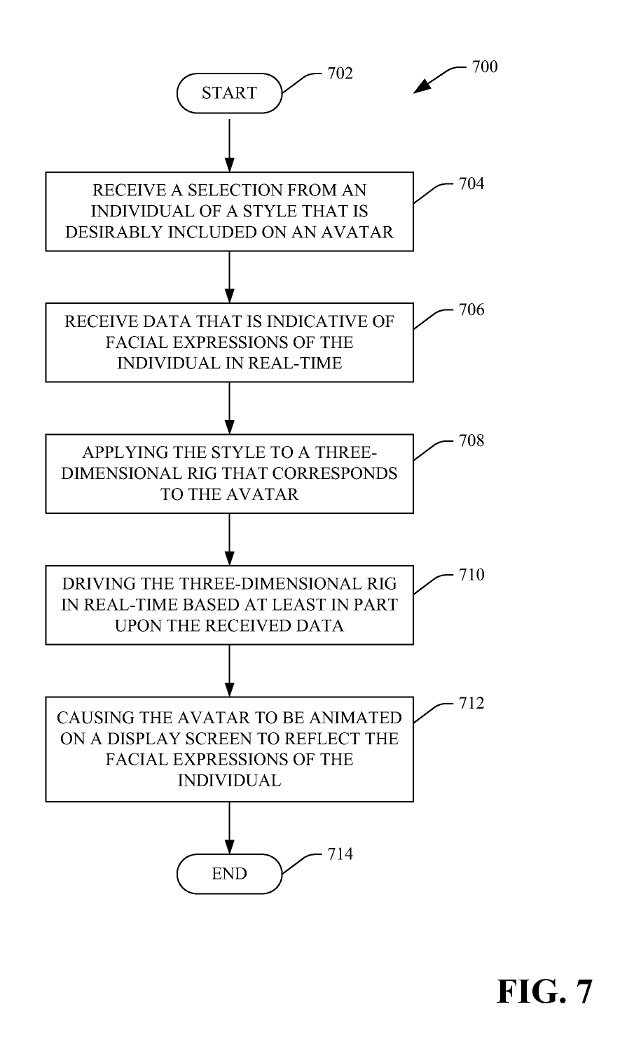

With reference now to FIGS. 6-7, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, a program, a thread of execution, and/or the like. Still further, results of acts of the methodologies may be stored in a computer-readable medium, displayed on a display device, and/or the like. The computer-readable medium may be a non-transitory medium, such as memory, hard drive, CD, DVD, flash drive, or the like.

Referring now to FIG. 6, a methodology 600 that facilitates causing a character (avatar) to be animated on a display screen to reflect the facial expressions of individuals in real-time is illustrated. The methodology 600 begins at 602, and at 604 a stream of video data is received from a sensor unit that comprises a video camera. The video camera is directed toward an individual, and thus the video stream comprises images of the individual over several frames.

At 606, data is extracted from the stream of video that is indicative of facial expressions of the individual captured in the video frames. For instance, any suitable facial recognition/analysis software can be utilized in connection with extracting the data from the video stream that is indicative of the facial expressions of the individual captured in the video frames.

At 608, a character is caused to be animated on a display screen with facial expressions that correspond to the one or more facial expressions of the individual captured in the video frame. The character is animated based at least in part upon the data that was extracted from the video frame that is indicative of the facial expressions of the individual. Furthermore, the character is caused to be animated in real-time to substantially instantaneously reflect the facial expressions of the individual as such individual makes such facial expressions. The methodology 600 completes at 610.

With reference now to FIG. 7, an example methodology 700 that facilitates causing an avatar to be animated on a display screen to reflect facial expressions of an individual in real-time is illustrated. The methodology 700 starts at 702, and at 704 a selection from an individual of a style that is desirably included on an avatar is received. This selection may be of a particular style of facial feature that is desirably included on the avatar.

At 706, data is received that is indicative of facial expressions of the individual in real-time. This data can be received from an image sensor and as described above, can be processed by facial recognition software.

At 708, the style is applied to an appropriate position on a 3D rig that is representative of a human face. Thus, if the style is an eyebrow, a representation of the eyebrow can be applied to the location on the 3D rig that corresponds to an eyebrow. At 710, the 3D rig is driven in real time based at least in part upon the data received at act 706. Therefore, the 3D rig moves as the face on the individual moves. At 712, the avatar is caused to be animated on a display screen to reflect the facial expressions of the individual in real-time. The methodology 700 completes at 714.

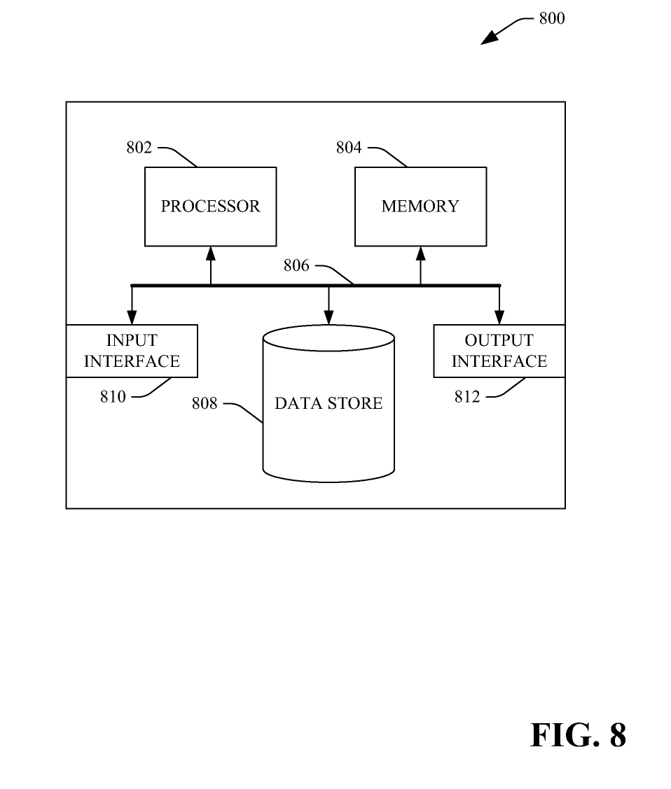

Now referring to FIG. 8, a high-level illustration of an example computing device 800 that can be used in accordance with the systems and methodologies disclosed herein is illustrated. For instance, the computing device 800 may be used in a system that supports animating an avatar that represents facial expressions of an individual represented by such avatar in real time. In another example, at least a portion of the computing device 800 may be used in a system that supports online gaming where telepresence is desired. The computing device 800 includes at least one processor 802 that executes instructions that are stored in a memory 804. The memory 804 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 802 may access the memory 804 by way of a system bus 806. In addition to storing executable instructions, the memory 804 may also store a 3D rig, a plurality of selectable styles to apply to an avatar of an individual, etc.

The computing device 800 additionally includes a data store 808 that is accessible by the processor 802 by way of the system bus 806. The data store may be or include any suitable computer-readable storage, including a hard disk, memory, etc. The data store 808 may include executable instructions, one or more avatars created by one or more individuals, video game data, a 3D rig, etc. The computing device 800 also includes an input interface 810 that allows external devices to communicate with the computing device 800. For instance, the input interface 810 may be used to receive instructions from an external computer device, from a user, etc. The computing device 800 also includes an output interface 812 that interfaces the computing device 800 with one or more external devices. For example, the computing device 800 may display text, images, etc. by way of the output interface 812.

Additionally, while illustrated as a single system, it is to be understood that the computing device 800 may be a distributed system. Thus, for instance, several devices may be in communication by way of a network connection and may collectively perform tasks described as being performed by the computing device 800.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices. Furthermore, a component or system may refer to a portion of memory and/or a series of transistors.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method comprising the following computer-executable acts:
receiving data that is indicative of facial expressions of an individual, wherein the stream of data is derived from a stream of motion data that captures motion of the individual; and
causing a character to be animated on a display screen with facial expressions that correspond to the one or more facial expressions of the individual based at least in part upon the data that is indicative of the one or more facial expressions of the individual.

2. The method of claim 1, wherein causing the character to be animated on the display screen with facial expressions that correspond to the one or more facial expressions of the individual comprises mapping the data pertaining to the one or more facial expressions of the individual to a three-dimensional computer-implemented rig that corresponds to the character.

3. The method of claim 2, wherein the character is an avatar that has styles that are customized by the individual.

4. The method of claim 3, further comprising:
receiving a selection of a style from the individual;
mapping the style to a position on the three-dimensional computer-implemented rig that corresponds to the style; and
animating the style on the character to represent the facial expressions of the individual.

5. The method of claim 4, wherein a graphical processing unit is configured to animate the style on the character to represent the facial expressions of the individual.

6. The method of claim 1, wherein a video game console is configured to execute the computer-executable acts.

7. The method of claim 1, further comprising:
receiving the stream of motion data from a sensor unit; and
extracting the data that is indicative of the facial expressions of the individual from the stream of motion data.

8. The method of claim 7, wherein the sensor unit is configured with a depth-sensing sensor, and wherein causing the character to be animated on the display screen with the facial expressions that correspond to the one or more facial expressions of the individual is based at least in part upon output of the depth-sensing sensor.

9. The method of claim 7, wherein the sensor unit is configured with a microphone, and wherein causing the character to be animated on the display screen with the facial expressions that correspond to the one or more facial expressions of the individual is based at least in part upon audible sounds captured by the microphone.

10. The method of claim 1, wherein the display screen is at a location that is remote from the individual.

11. The method of claim 1, further comprising:
receiving a stream of data that is representative of facial expressions of a second individual, wherein the second individual is at a location that is remote from the display screen; and
causing a second character to be animated on the display screen with facial expressions that correspond to the facial expressions of the second individual based at least in part upon the stream of data that is representative of facial expressions of the second individual.

12. The method of claim 11, further comprising:
transmitting the data pertaining to the one or more facial expressions of the individual to a video game console utilized by the second individual.

13. A computing apparatus, comprising:
a processor; and
a memory that comprises components that are executable by the processor, the components comprising:
a facial recognition component that receives a motion data stream and extracts data therefrom that is indicative of facial expressions of an individual whose movement is captured in the motion data stream; and
a render component that causes a character to be animated on a display screen, wherein the character is animated to reflect the facial expressions of the individual that is captured in the video stream based at least in part upon the data extracted from the motion data stream.

14. The computing apparatus of claim 13 being a video game console.

15. The computing apparatus of claim 13, further comprising a sensor unit that comprises a video camera, wherein the video camera is configured to generate the motion data stream.

16. The computing apparatus of claim 13, wherein the memory further comprises a driver component that drives a three-dimensional computer-implemented rig based at least in part upon the data extracted from the motion data stream that is indicative of the facial expressions of the individual, and wherein the render component animates the character based at least in part upon the three-dimensional rig.

17. The computing apparatus of claim 16, further comprising:
an interface component that receives a selection from the individual of at least one style from amongst a plurality of selectable styles pertaining to the character, wherein the individual desires that the character be displayed on the display screen in accordance with the at least one style; and
an applier component that applies the at least one style to an appropriate location on the three-dimensional rig, wherein the render component is configured to animate the at least one style on the character based at least in part upon the data extracted from the motion data stream.

18. The computing apparatus of claim 13, wherein the individual and the display screen are remote from one another.

19. The computing apparatus of claim 13 being a portable computing device.

20. A computer-readable medium in a video game console comprising instructions that, when executed by a processor, cause the processor to perform acts comprising:
receiving a selection from an individual of a style that is desirably included on an avatar;
receiving data that is indicative of facial expressions of the individual in real-time;
applying the style to a three-dimensional rig that corresponds to the avatar;
driving the three-dimensional rig in real-time based at least in part upon the data that is indicative of the facial expressions of the individual; and
causing the avatar to be animated to be displayed on a display screen to reflect the facial expressions of the individual, wherein the avatar is animated such that the style is animated to reflect the facial expressions of the individual.
